(19) United States
(12) Patent Application Publication
(10) Pub. No.: US 2018/0089044 A1
(43) Pub. Date: Mar. 29, 2018

(54) TECHNOLOGIES FOR PROVIDING NETWORK INTERFACE SUPPORT FOR REMOTE MEMORY AND STORAGE FAILOVER PROTECTION

(71) Applicants: Francesc Guim Bernat, Barcelona (ES); Karthik Kumar, Chandler, AZ (US); Thomas Willhalm, Sandhausen (DE); Patrick Lu, Mesa, AZ (US); Daniel Rivas Barragan, Cologne (DE)

(72) Inventors: Francesc Guim Bernat, Barcelona (ES); Karthik Kumar, Chandler, AZ (US); Thomas Willhalm, Sandhausen (DE); Patrick Lu, Mesa, AZ (US); Daniel Rivas Barragan, Cologne (DE)

(21) Appl. No.: 15/277,522

(22) Filed: Sep. 27, 2016

(51) Int. Cl. G06F 11/20; G06F 12/14

(52) U.S. Cl. CPC G06F 11/2069; G06F 12/1425

(57) ABSTRACT

Technologies for providing network interface support for remote memory and storage failover protection include a compute node. The compute node includes a memory to store one or more protected resources and a network interface. The network interface is to receive, from a requestor node in communication with the compute node, a request to access one of the protected resources. The request identifies the protected resource by a memory address. Additionally, the network interface is to determine an identity of the requestor node and determine, as a function of the identity and permissions data associated with the memory address, whether the requestor node has permission to access the protected resource. Other embodiments are described and claimed.

### BACKGROUND

Present trends in data center architecture indicate a greatly increased focus on the fabric (e.g., the network) being the mechanism that binds several entities together. However, typical systems do not provide the ability to access memory, such as address ranges of random access memory (RAM), over the fabric in a manner that is transparent to a compute device that is requesting access to the memory and that is based on permissions associated with different memory regions. As such, even in specialized systems in which one compute device enables access to a region of memory to other compute devices, events may occur that cause writes or reads to the memory region among the compute devices to become desynchronized, such as due to loss of network connectivity of one or more of the compute devices. As a result, data in the memory region may become corrupted.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for remote memory and storage failover protection in a set of networked nodes;

FIG. 2 is a simplified block diagram of at least one embodiment of a node included in the system of FIG. 1;

FIG. 3 is a simplified block diagram of at least one embodiment of an environment that may be established by a node included in the system of FIG. 1;

FIGS. 4-5 are a simplified flow diagram of at least one embodiment of a method for managing access to protected resources that may be performed by a node in the system of FIG. 1;

FIG. 6 is a simplified block diagram of at least one embodiment of a method for managing failovers that may be performed by a node in the system of FIG. 1;

FIG. 7 is a simplified diagram of at least one embodiment of example communications that may be transmitted among the nodes in the system of FIG. 1 to provide remote memory and storage failover protection.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

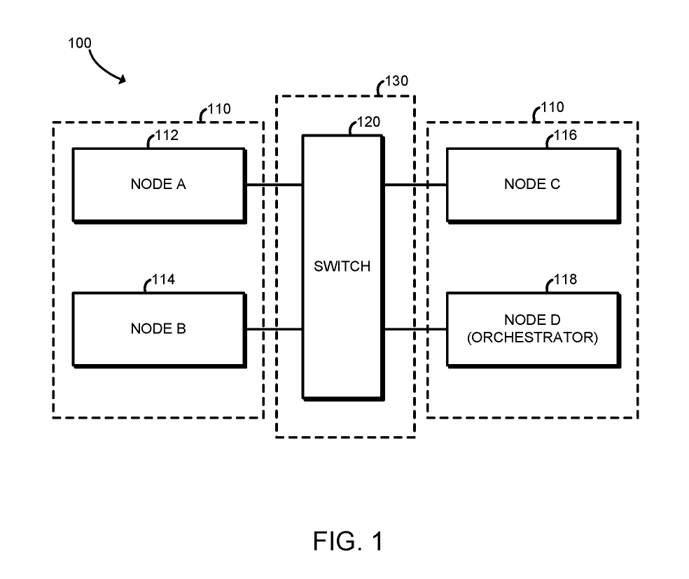

As shown in FIG. 1, an illustrative networked system 100 in which multiple nodes 110 have network interface (e.g., a network interface controller (NIC) such as a host fabric interface (HFI) discussed at http://www.intel.com/content/www/us/en/high-performance-computing-fabrics/omni-path-host-fabric-interface.html, https://en.wikipedia.org/wiki/Omni-Path) support for remote memory and storage failover protection. The nodes 110 illustratively include a node 112, a node 114, a node 116, and a node 118, which is configured as an orchestrator to assist in coordinating memory accesses among the other nodes 112, 114, 116 in the illustrative embodiment. The nodes 110 are connected to a switch 120 of a network 130 to facilitate communication among the nodes 110 through their respective network interfaces. In operation, the nodes 110 may use an NVM Express (NVMe) protocol (http://www.nvmexpress.org/nvm-express-over-fabrics-specification-released/), or remote direct memory access (RDMA) protocol (http://www.rdmaconsortium.org/), to access the memory of another node over the fabric, such as to write or read data as if the memory was local to the respective node 110. To enable the access to memory over the fabric to be similar in speed to access to local memory, the nodes 110 reduce or eliminate intervention by any software applications. However, without software applications to intercept and process such memory access requests, complex challenges regarding permissions and memory corruption may arise. In the illustrative embodiments, the nodes 110, and more specifically, the network interfaces of the nodes 110, implement permissions for various memory regions in a node to be read-only for a set of nodes 110, read-write for another set of nodes 110, and/or read-write-own for yet another set of nodes 110. As such, the system 100 provides failover protection by enabling the nodes 110 to perform operations in accordance with roles and corresponding permissions, and to adapt to instances in which one node may become inoperative and another node is to take over the role of, and assume the permissions of, the inoperative node until the inoperative node becomes operative again.

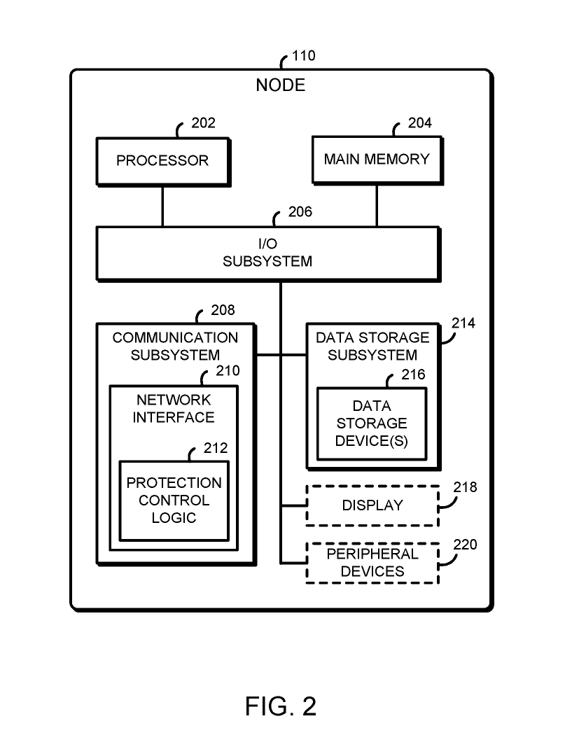

Referring now to FIG. 2, each node 110 may be embodied as any type of computing device capable of performing the functions described herein, including transmitting or receiving a request to read from or write to a memory region in the node 110 and managing permissions associated with the memory regions. For example, the node 110 may be embodied as a server, a server blade, a desktop computer, a notebook, a laptop computer, a netbook, an Ultrabook™, and/or any other computing/communication device. As shown in FIG. 2, the illustrative node 110 includes a processor 202, a main memory 204, an input/output (“I/O”) subsystem 206, a communication subsystem 208, and a data storage subsystem 214. Of course, the node 110 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component. For example, the memory 204, or portions thereof, may be incorporated in the processor 202 in some embodiments.

The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 204 may be embodied as any type of volatile or non-volatile memory or data storage capable of performing the functions described herein. In operation, the memory 204 may store various data and software used during operation of the node 110 such as data protected by permissions, operating systems, applications, programs, libraries, and drivers. The memory 204 is communicatively coupled to the processor 202 via the I/O subsystem 206, which may be embodied as circuitry and/or components to facilitate input/output operations with the processor 202, the memory 204, and other components of the node 110. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a-chip (SoC) and be incorporated, along with the processor 202, the memory 204, and other components of the node 110, on a single integrated circuit chip.

The communication subsystem 208 may be embodied as one or more devices and/or circuitry capable of enabling communications with one or more other compute devices, such as other nodes 110, the switch 120, or other compute devices. The communication circuitry 208 may be configured to use any one or more communication technology (e.g., wired or wireless communications) and associated protocols (e.g., Ethernet, Bluetooth®, Wi-Fi®, WiMAX, etc.) to effect such communication. In the illustrative embodiment, the communication subsystem 208 includes a network interface 210 which may be embodied as one or more add-in-boards, daughtercards, network interface cards, controller chips, chipsets, or other devices or circuitry to communicatively connect the node 110 to another compute device through the fabric. In the illustrative embodiment, the network interface 210 includes protection control logic 212, which may be embodied as any one or more devices and/or circuitry to determine an identity of a node requesting access to a memory region, allow or deny access to the memory region based on a set of permissions accessible to the protection control logic 212, and modify the permissions in response to updates from a node 110 that has ownership rights to a particular memory region (e.g., the orchestrator node 118).

The data storage subsystem 214 may be embodied as any type of device or devices configured for short-term or long-term storage of data. As such, the data storage system 214 includes one or more data storage devices 216, such as, for example, one or more solid state drives (SSDs), one or more hard disk drives (HDDs), memory devices and circuits, memory cards, or other data storage devices. The data storage subsystem 214 may store data protected by permissions, operating systems, applications, programs, libraries, and drivers, as described in more detail herein.

The data storage device 216, which may be embodied as any device capable of writing and reading data as described herein, may be incorporated in, or form a portion of, one or more other components of the node 110. For example, the data storage device 216 may be embodied as, or otherwise be included in, a solid state drive, a hard disk drive, or other components of the node 110, such as the main memory 204. The data storage device 216 may include a data storage controller and a memory, which may include non-volatile memory and volatile memory. The data storage controller may be embodied as any type of control device, circuitry, or collection of hardware devices capable of performing the functions described herein. In the illustrative embodiment, the data storage controller may include a processor or processing circuitry, local memory, a host interface, a buffer, and memory control logic (also referred to herein as a “memory controller”). The memory controller can be in the same die or integrated circuit as the processor or the memory or in a separate die or integrated circuit than those of the processor and the memory. In some cases, the processor, the memory controller, and the memory can be implemented in a single die or integrated circuit. Of course, the data storage controller may include additional devices, circuits, and/or components commonly found in a drive controller of a solid state drive in other embodiments.

Still referring to FIG. 2, the node 110 may additionally include a display 218, which may be embodied as any type of display device on which information may be displayed to a user of the node 110. The display 218 may be embodied as, or otherwise use, any suitable display technology including, for example, a liquid crystal display (LCD), a light emitting diode (LED) display, a cathode ray tube (CRT) display, a plasma display, and/or other display usable in a compute device. The display 218 may include a touchscreen sensor that uses any suitable touchscreen input technology to detect the user's tactile selection of information displayed on the display including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors.

In some embodiments, the node 110 may further include one or more peripheral devices 220. Such peripheral devices 220 may include any type of peripheral device commonly found in a compute device such as speakers, a mouse, a keyboard, and/or other input/output devices, interface devices, and/or other peripheral devices.

Referring back to FIG. 1, the switch 120 may be embodied as any compute device capable of connecting the nodes 110 together on the network 130, such as by using packet switching to receive, process and forward data from one node 110 to another node 110. The switch 120 may include components commonly found in a compute device, such as a processor, memory, I/O subsystem, data storage, communication subsystem, etc. Those components may be substantially similar to the corresponding components of the node 110, with the exception that the protection control logic 212, in the illustrative embodiment, is specific to the nodes 110. As such, further descriptions of the like components are not repeated herein with the understanding that the description of the corresponding components provided above in regard to the node 110 applies equally to the corresponding components of the switch 120.

Still referring to FIG. 1, as described above, the nodes 110 are illustratively in communication via the network 130, which may be embodied as any number of various wired or wireless networks. For example, the network 130 may be embodied as, or otherwise include, a wired or wireless local area network (LAN), a wired or wireless wide area network (WAN), a cellular network, and/or a publicly-accessible, global network such as the Internet. As such, the network 130 may include any number of additional devices, such as additional computers, routers, and switches (e.g., the switch 120), to facilitate communications among the nodes 110.

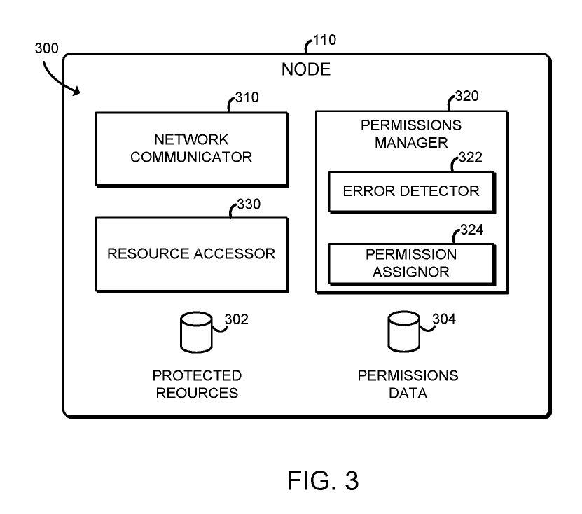

Referring now to FIG. 3, in use, each node 110 may establish an environment 300. The illustrative environment 300 includes a network communicator 310, a permissions manager 320, and a resource accessor 330. Each of the components of the environment 300 may be embodied as firmware, software, hardware, or a combination thereof. For example the various components and logic of the environment 300 may form a portion of, or otherwise be established by, the processor 202 or other hardware components of the node 110. As such, in some embodiments, any one or more of the components of the environment 300 may be embodied as a circuit or collection of electrical devices (e.g., a network communicator circuit 310, a permissions manager circuit 320, a resource accessor circuit 330, etc.). In the illustrative embodiment, the environment 300 additionally includes protected resources 302, which may be embodied as data in regions of the memory 204, 214 and/or memory-mapped I/O devices, having permissions assigned to them. The environment 300 also includes permissions data 304, which may be embodied as identifications of memory regions (e.g., the protected resources 302), such as memory address ranges, identifications of devices and/or groups of devices (e.g., nodes 110), the types of access each identified device and/or group of devices has to each region (e.g., read access, write access, ownership), and/or any other data or metadata usable to control access of the nodes 110 to the protected resources.

In the illustrative embodiment, the network communicator 310, which may be embodied as hardware, firmware, software, virtualized hardware, emulated architecture, and/or a combination thereof as discussed above, is configured to transmit or receive a request to access a protected resource 302, transmit or receive data to be written to the protected resource 302, transmit or receive data read from the protected resource 302, receive a request the change the permissions associated with a protected resource 302, report a status update or error, such as a permissions violation, to another node 110, such as the orchestrator node 118, and/or to transmit or receive other data.

In the illustrative embodiment, the permissions manager 320, which may be embodied as hardware, firmware, software, virtualized hardware, emulated architecture, and/or a combination thereof as discussed above, is configured to, in response to a request to access a protected resource 302 (i.e., data stored in a specified memory region), determine whether the requesting node 110 has the requested type of access to the protected resource and grant access to the node 110 if the node 110 has the appropriate permissions, or generate an error, such as a permissions violation error, if the node 110 does not have the appropriate permissions. Further, the permissions manager 320 is configured to reassign permissions to and from the nodes 110 in response to status updates regarding the nodes 110, such as whether a particular node 110 has become inoperative and a backup node 110 is to instead receive access to a particular protected resource 302, and/or in response to requests from the orchestrator node 118 to reassign the permissions. To do so, in the illustrative embodiment, the permissions manager 320 includes an error detector 322 and a permission assignor 324.

Depending on whether the node 110 is acting as an orchestrator node or not, the error detector 322 and the permission assignor 324 are configured to perform different operations. If the node 110 is to operate as the orchestrator node 118, the error detector is configured to determine whether a particular node 110 has become inoperative (e.g., disconnected from the network 130, malfunctioning, etc.). The error detector 322 may make this determination based on periodic status updates from each node 110, from transmitting queries to the nodes 110 to determine their status and receiving and analyzing responses from the nodes 110, from a lack of a response from one or more nodes 110, and/or based on other factors. In response to a determination that a particular node 110 is inoperative or malfunctioning, the permission assignor 324 may reassign the permissions originally associated with that node 110 to another node, such as a node that has been designated as a backup. Subsequently, if the original node 110 returns to normal operation, the error detector 322 may identify an error message, such as a permissions violation message, that the original node attempted to access a protected resource 302 that it previously had permission to access (i.e., before the permission assignor 324 reassigned those permissions to the backup node 110). In response, the permission assignor 324 may revoke the permissions from the backup node 110 and reassign them to the original node 110. The permission assignor 324 may perform these changes in permissions by transmitting requests to do so to the node 110 in which the protected resources 302 actually reside.

In embodiments in which the error detector 322 and permission assignor 324 are in a node 110 that is not to operate as the orchestrator node 118, the error detector 322 may determine that a node 110 has requested access to a protected resource 302 that the requesting node 110 does not have permission to access, and may report the permissions violation to the requesting node 110 and/or to the orchestrator node 118. Furthermore, in such embodiments, the permission assignor 324 is configured to receive, from a node 110, such as the orchestrator node 118, a request to change the permissions associated with one or more protected resources 302, determine whether the node 110 requesting the change in permissions has the appropriate rights to change the permissions (e.g., ownership permission or the requesting node is the orchestrator node 118), and, reassign, in response to a determination that the requesting node has the appropriate rights, the permissions associated with the one or more protected resources 302.

It should be appreciated that each of the error detector 322 and the permission assignor 324 may be separately embodied as hardware, firmware, software, virtualized hardware, emulated architecture, and/or a combination thereof. For example, the error detector 322 may be embodied as a hardware component, while the permission assignor 324 is embodied as a virtualized hardware component or as some other combination of hardware, firmware, software, virtualized hardware, emulated architecture, and/or a combination thereof.

The resource accessor 330, which may be embodied as hardware, firmware, software, virtualized hardware, emulated architecture, and/or a combination thereof as discussed above, is configured to generate a request to another node 110 for read or write access to a protected resource 302. Similarly, the resource accessor 330 is configured provide access to a protected resource 302 in response to a request from the permissions manager 320 to do so (i.e., after the permissions manager 320 has verified that the requesting node 110 has the appropriate permission). In providing the requested access, the resource accessor 330 may read data from a protected resource 302 and provide the data to the network communicator for transmission to the requesting node 110. The protected resource 302 may be identified by a memory address or address range, or a name or other identifier mapped to a memory address. As such, the resource accessor 330 may be configured to determine the physical address(es) associated with the request, and read the data from the physical address(es). Similarly, the resource accessor 330 may write data from the requesting node 110 to a memory address of a protected resource.

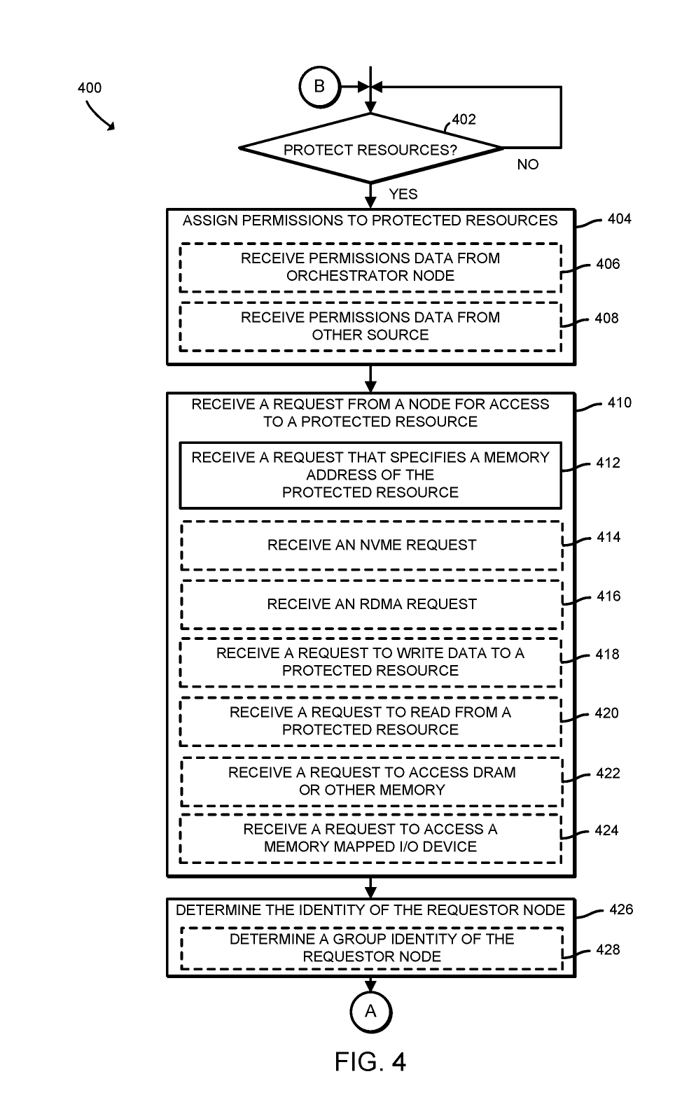

Referring now to FIG. 4, in use, a node 110, such as the node 116, may execute a method 400 for managing access to the protected resources 302. For clarity, the node 116 is described as performing the steps of the method 400. However, it should be understood that any node 110 in the system 100 may perform the method 400. Further, while the node 116 is described as performing the steps of the method 400, it should be understood that, in the illustrative embodiment, the steps are performed by the network interface 210 of the node 116, using the protection control logic 212. The method 400 begins with block 402 in which the node 116 determines whether to protect resources (e.g., the protected resource 302). In the illustrative embodiment, the node 116 determines to protect resources as long as the node 116 is powered on and operational. In other embodiments, the node 116 may determine to protect resources in response to a request received from a user, in accordance with a configuration file, or based on other factors. Regardless, in response to a determination to protect resources, the method 400 advances to block 404, in which the node 116 assigns permissions to the protected resources 302. In doing so, the node 116 may receive the permissions data 304 from the orchestrator node 118, as indicated in block 406. Additionally or alternatively, the node 116 may receive the permissions data 304 from another source, such as a local user or configuration file. In the illustrative embodiment, in assigning the permissions, the protection control logic 212 loads the permissions data 304 to enable the network interface 210 to quickly make determinations as to whether requesting nodes 110 have permission to access particular protected resources 302.

After assigning the permissions to the protected resources 302, the method 400 advances to block 410 in which the node 116 receives a request from a node 110 (e.g., node 114) for access to a protected resource 302. In doing so, in the illustrative embodiment, the node 116 receives a request that specifies a memory address of the protected resource 302, as indicated in block 412. In some embodiments, the memory address is a logical memory address to be mapped to a physical address, while in other embodiments, the memory address is a physical address. Further, in some embodiments, in receiving the request for access to a protected resource, the node 116 receives an NVMe request, as indicated in block 414. In other embodiments, the node 116 receives an RDMA request, as indicated in block 416. In other embodiments, the node 116 receives the request in a different format or protocol. In receiving the request, the node 116 may receive a request to write data to the protected resource 302, in block 418. Alternatively, the node 116 may receive a request to read data from the protected resource 302 in block 420. As indicated in block 422, the node 116 may receive a request to access DRAM (e.g., the main memory 204) or other memory, such as the data storage subsystem 214. Alternatively, as indicated in block 424, the node 116 may receive a request to access (e.g., read from or write to) a memory mapped I/O device, such as the display 218 or peripheral devices 220.

After receiving the request, the method 400 advances to block 426 in which the node 116 determines the identity of the requestor node (i.e., the node 110 that transmitted the request in block 410). In the illustrative embodiment, the requestor node 110 is the node 114, however it should be understood that in other embodiments, the requestor node may be any other node 110. The node 116 may determine the identity of the requestor node 114 based on an Internet protocol (IP) address of the requestor node 114 included in the request, which, in the illustrative embodiment, is an RDMA request, a media access control (MAC) address included in the request, or any other unique identifier of the requestor node 114. Further, in the illustrative embodiment, the node 116 determines a group identity of the requestor node 114, as indicated in block 428. In determining the group identity, the node 116 may compare the identity to the requestor node to a table or other data structure that associates individual node identities with group identities.

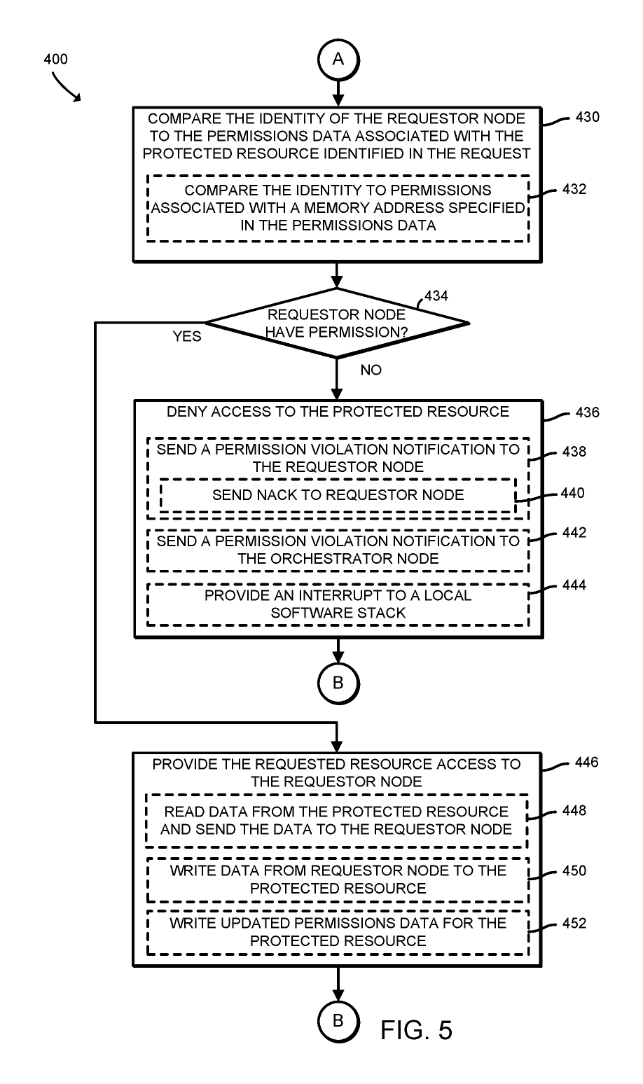

Referring now to FIG. 5, after determining the identity of the requestor node 114, the method 400 advances to block 430, in which the node 116 compares the identity of the requestor node 114 to the permissions data 304 associated with the protected resource 302 identified in the request. In doing so, as indicated in block 432, the node 116 may compare the identity to permissions associated with a memory address specified in the permissions data 304. As described above, in at least some embodiments, the node 116 determines a group identity associated with the node. In those embodiments, in comparing the identity to the permissions in the permissions data 304, the node 116 may compare the group identity to the permissions. As described above, the permissions data 304 may be embodied as a table, database, or any other data structure usable to associate a node identity or group identity with read permissions, write permissions, and/or ownership permissions (i.e., the right to reassign or change the permissions) for each of a set of protected resources 302.

After comparing the identity to the permissions data, the node 116 determines whether the requestor node 114 has permission for the type of access that was requested. If not, the method 400 advances to block 436 in which the node 116 denies access to the protected resource. In doing so, the node 116 may send a permission violation notification to the requestor node 114, as indicated in block 438. In doing so, in block 440, the node 116 may send a NACK (i.e., a negative acknowledgement) message to the requestor node. The NACK message, in the illustrative embodiment, is provided in a layer four protocol (i.e., the transport layer, such as the transmission control protocol (TCP)), rather than the NVMe or RDMA protocol. As indicated in block 442, the node 116 may send a permission violation notification to the orchestrator node 118 to inform the orchestrator node 118 that the requestor node 114 made a request for a resource that the requestor node 114 does not have permission to access. Additionally or alternatively, in block 444, the node 116 may provide an interrupt to a local software stack of the node 116 to perform additional operations, such as to display an error message on the display 218.

Referring back to block 434, if the node 116 instead determines that the requestor node 114 does have permission, the method 400 advances to block 446, in which the node 116 provides the requested resource access to the requestor node 114. In doing so, the node 116 may read data from the protected resource 302 and send the data to the requestor node 114, as indicated in block 448. Alternatively, the node 116 may write data from the requestor node 114 to the protected resource 302 indicated in block 450 or may write updated permissions data 304 for the protected resource 302, as indicated in block 452, such as adding permission for a type of access for one of the nodes 110 or removing permission for a type of access for one of the nodes 110. After denying access or providing access to the protected resource 302, the method 400 returns to block 402, in which the node 116 determines whether to continue protecting resources.

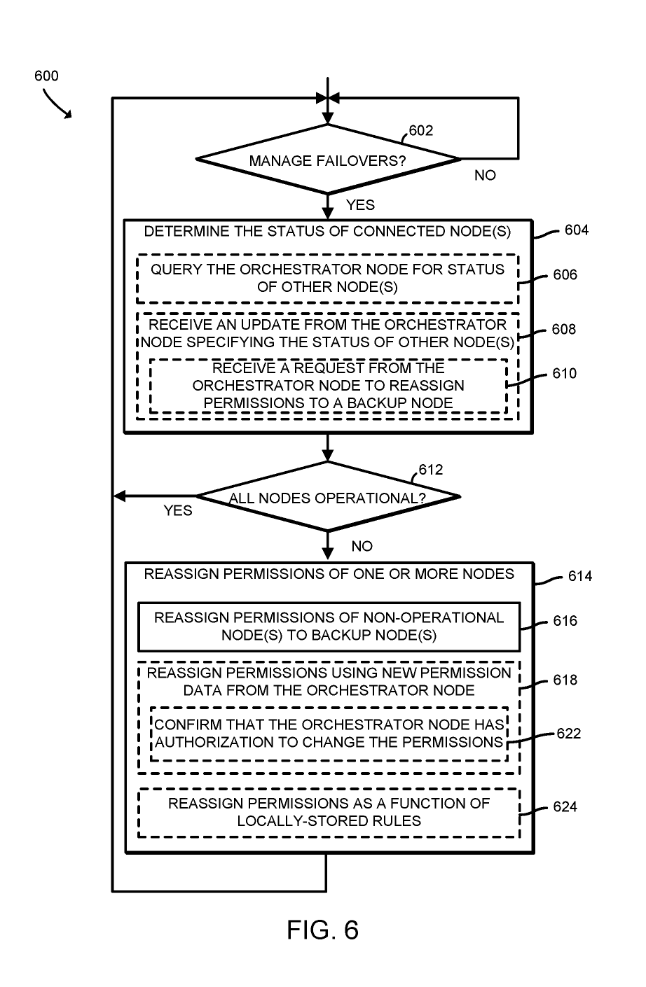

Referring now to FIG. 6, in use, one of the nodes 110, may perform a method 600 for managing failovers. In the illustrative embodiment, the network interface 210 of the node 110 performs the method 600, using the protection control logic 212. The method 600 begins with block 602 in which the node 110 determines whether to manage failovers. In the illustrative embodiment, the node 110 may determine to manage failovers if the node 110 is powered on and operational. In other embodiments, the node 116 may determine to protect resources in response to a request received from a user, in accordance with a configuration file, or based on other factors. Regardless, in response to a determination to manage failovers, the method 600 advances to block 604 in which the node 110 determines the status of other connected nodes 110 in the system 100. For example, a non-orchestrator node 110, such as the node 116, may query the orchestrator node 118 for the status of the other nodes 110, as indicated in block 606. Further, the node 110 may receive an update from the orchestrator node 118 specifying the status of the other nodes 110, as indicated in block 608. As indicated in block 610, in receiving the update, the node 110 may receive a request from the orchestrator node 118 to reassign permissions for one or more of the protected resources 302 to a backup node 110, such as if the original node 110 that had the permissions is no longer operational. In other embodiments, the node 110 may be the orchestrator node 118 or may otherwise directly determine the status of the other nodes 110 rather than receiving such information from the orchestrator node 118.

In block 612, the node 110 determines whether all of the nodes are operational (e.g., powered on and communicating over the network 130 through the switch 120). If so, the method 600 returns to block 602 in which the node 110 determines whether to continue managing failovers. Otherwise, the method 600 advances to block 614 in which the node 110 reassigns permissions of one or more of the nodes 110. In doing so, the node 110 may reassign permissions of non-operational nodes 110 to backup nodes 110, as indicated in block 616. As indicated in block 618, the node 110 may reassign the permissions using new permission data from the orchestrator node 118. In doing so, as indicated in block 622, the node 110 may confirm that the orchestrator node 118 has authorization to change the permissions, such as by comparing an identifier associated with the orchestrator node 118 to the permissions data 304, as described in more detail above, with regard to the method 400. Alternatively, as indicated in block 624, the node 110 may reassign the permissions as a function of locally-stored rules, such as when the node 110 is to perform at least some of the functions the orchestrator node 118. After reassigning the permissions, the method 600 returns to block 602 in which the node 110 determines whether to continue managing failovers.

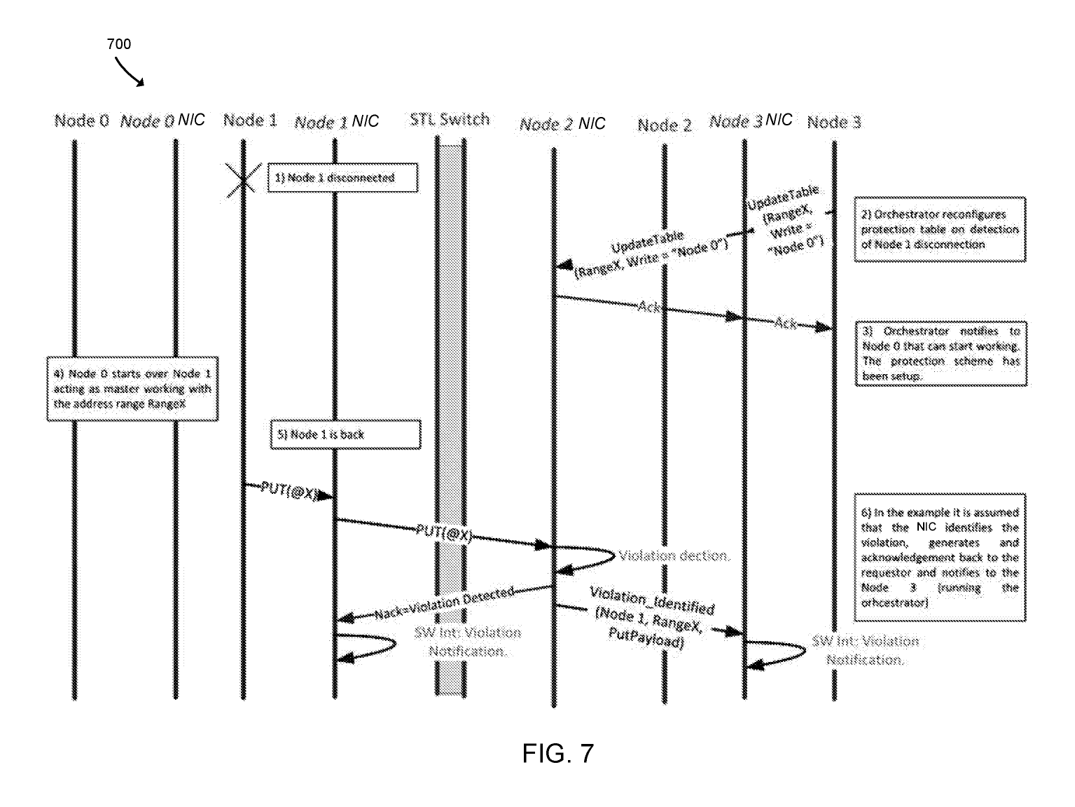

Referring now to FIG. 7, an example embodiment of communications 700 among the nodes 110 is shown. Initially, a node 110, such as the node 114, which initially had permissions to a particular protected resource of another node 110, such as the node 116, becomes disconnected from the network 130. Subsequently, an orchestrator node, such as the orchestrator node 118, determines that the node 114 is inoperative and transmits a request to the node 116 to reassign permissions for the protected resource 302 to another node 110, such as the node 112. In particular, the orchestrator node 118 transmits a request that specifies that the node 112 is to receive write permissions to a particular address range corresponding to the protected resource 302. The node 116 receives the request from the orchestrator node 118, confirms that the orchestrator node 118 has authorization to change the permissions, changes the permissions in the permissions data 304 in accordance with the request, and transmits a notification the orchestrator node 118 that the node 116 has updated the permissions. Subsequently, the orchestrator node 118 transmits a notification to the node 112 indicating that the node 112 is to perform the functions that were previously performed by the node 114. In response to receiving the notification, the node 112 accesses (e.g., reads from and/or writes to) the protected resource 302 on the node 116, using the permissions that were reassigned to it.

The node 114 then becomes operational again and, because it was disconnected from the network 130, is unaware that it has lost permissions to the protected resource 302. The node 114 transmits a request to access the protected resource 302. More specifically, the node 114 transmits a request to write data to the protected resource 302. In response, the node 116 determines that the node 114 does not have access to the protected resource 302 and transmits a permission violation message back to the node 114 and a separate message to the orchestrator node 118. The messages are transport layer messages (e.g., transmission control protocol messages) that are sent and received between the network interfaces 210 of the nodes. The network interface 210 proxies the semantics of the message to the application or process running on the respective node 110. An example format of the message may be Response(TransactionNotAccepted, PermissionViolation). The orchestrator node 118 receives the message and generates a software interrupt to a software stack (e.g., a software interrupt formatted as Interrupt(REMOTE_VIOLATION, Address=@ ViolatedAddress, RemoteNode=NODE_ID) to determine a corrective action, such as transmitting a new message, which may be embodied as a combination of the previous two messages, to the node 114 to stop attempting to access the protected resource 302. Alternatively, the orchestrator node 118 may transmit a new message (e.g., SocketSend(Dest=NodeRunningTheAppDoingBadWrites, Port=PortWhereAppDoingBadReadsIsWaitingForOrchestratorNotification, Data=“Violation Occurred”)) to the node 112 indicating the node 114 has resumed operation and that the node 112 is to stop accessing the protected resource 302, and transmit a new request to the node 116 (e.g., SocketSend(Dest=NodeWithResource,Port=ListenPortOfNodeWithResource, Data=“ReassignPermissions”)) to reassign the permissions back to the node 114.

### EXAMPLES

Example 1 includes a compute node comprising a memory to store one or more protected resources; a network interface to receive, from a requestor node in communication with the compute node, a request to access one of the protected resources, wherein the request identifies the protected resource by a memory address; determine an identity of the requestor node; and determine, as a function of the identity and permissions data associated with the memory address, whether the requestor node has permission to access the protected resource.

Example 2 includes the subject matter of Example 1, and wherein the network interface is further to provide, in response to a determination that the requestor node has permission to access the protected resource, access to the protected resource to the requestor node.

Example 3 includes the subject matter of any of Examples 1 and 2, and wherein to provide access to the protected resource comprises to write data from the requestor node to the memory address.

Example 4 includes the subject matter of any of Examples 1-3, and wherein to provide access to the protected resource comprises to read data from the memory address; and send the read data to the requestor node.

Example 5 includes the subject matter of any of Examples 1-4, and wherein the network interface is further to deny, in response to a determination that the requestor node does not have permission to access the protected resource, access to the protected resource to the requestor node.

Example 6 includes the subject matter of any of Examples 1-5, and wherein to deny access further comprises to send a permission violation notification to the requestor node.

Example 7 includes the subject matter of any of Examples 1-6, and wherein to deny access further comprises to send a NACK message to the requestor node.

Example 8 includes the subject matter of any of Examples 1-7, and wherein to deny access further comprises to send a permission violation notification to an orchestrator node to manage an operation of the requestor node.

Example 9 includes the subject matter of any of Examples 1-8, and wherein to deny access further comprises to provide an interrupt to a local software stack of the compute node.

Example 10 includes the subject matter of any of Examples 1-9, and wherein the network interface is further to receive permissions data from an orchestrator node coupled to the compute node through a network, wherein the permissions data identifies one or more other nodes that are to have permissions that include at least one of write access, read access, or ownership of the one or more protected resources; determine, in response to receipt of the permissions data, whether the orchestrator node has authorization to change the permissions to the one or more protected resources; and assign, in response to a determination that the orchestrator node is authorized to change the permissions, the permissions to the protected resources as a function of the permissions data.

Example 11 includes the subject matter of any of Examples 1-10, and wherein the network interface is further to receive a request to reassign permissions associated with one or more of the protected resources from a first node to a second node coupled to the compute node through a network; and reassign, in response to receipt of the request, the permissions from the first node to the second node.

Example 12 includes the subject matter of any of Examples 1-11, and wherein to receive a request to access one of the protected resources comprises to receive a request to access a memory mapped input/output (IO) device.

Example 13 includes the subject matter of any of Examples 1-12, and wherein to receive a request to access one of the protected resources comprises to receive a request to access dynamic random access memory (DRAM).

Example 14 includes the subject matter of any of Examples 1-13, and wherein to receive the request to access one of the protected resources comprises to receive a request to access non-volatile memory.

Example 15 includes the subject matter of any of Examples 1-14, and wherein to receive a request to access one of the protected resources comprises to receive a request in a non-volatile memory express (NVMe) format.

Example 16 includes the subject matter of any of Examples 1-15, and wherein to receive a request to access one of the protected resources comprises to receive a request in a remote direct memory access (RDMA) format.

Example 17 includes a method comprising receiving, by a network interface of a compute node, from a requestor node in communication with the compute node, a request to access a protected resource in a memory of the compute node, wherein the request identifies the protected resource by a memory address; determining, by the network interface, an identity of the requestor node; and determining, by the network interface, as a function of the identity and permissions data associated with the memory address, whether the requestor node has permission to access the protected resource.

Example 18 includes the subject matter of Example 17, and further including providing, by the network interface and in response to a determination that the requestor node has permission to access the protected resource, access to the protected resource to the requestor node.

Example 19 includes the subject matter of any of Examples 17 and 18, and wherein providing access to the protected resource comprises writing data from the requestor node to the memory address.

Example 20 includes the subject matter of any of Examples 17-19, and wherein providing access to the protected resource comprises reading, by the network interface, data from the memory address; and sending, by the network interface, the read data to the requestor node.

Example 21 includes the subject matter of any of Examples 17-20, and further including denying, by the network interface and in response to a determination that the requestor node does not have permission to access the protected resource, access to the protected resource to the requestor node.

Example 22 includes the subject matter of any of Examples 17-21, and wherein denying access further comprises sending a permission violation notification to the requestor node.

Example 23 includes the subject matter of any of Examples 17-22, and wherein denying access further comprises to sending a NACK message to the requestor node.

Example 24 includes the subject matter of any of Examples 17-23, and wherein denying access further comprises sending a permission violation notification to an orchestrator node to manage an operation of the requestor node.

Example 25 includes the subject matter of any of Examples 17-24, and wherein denying access further comprises providing an interrupt to a local software stack of the compute node.

Example 26 includes the subject matter of any of Examples 17-25, and further including receiving, by the network interface, permissions data from an orchestrator node coupled to the compute node through a network, wherein the permissions data identifies one or more other nodes that are to have permissions that include at least one of write access, read access, or ownership of the one or more protected resources; determining, by the network interface and in response to receipt of the permissions data, whether the orchestrator node has authorization to change the permissions to the one or more protected resources; and assigning, by the network interface and in response to a determination that the orchestrator node is authorized to change the permissions, the permissions to the protected resources as a function of the permissions data.

Example 27 includes the subject matter of any of Examples 17-26, and further including receiving, by the network interface, a request to reassign permissions associated with one or more of the protected resources from a first node to a second node coupled to the compute node through a network; and reassigning, by the network interface, in response to receipt of the request, the permissions from the first node to the second node.

Example 28 includes the subject matter of any of Examples 17-27, and wherein receiving a request to access one of the protected resources comprises receiving a request to access a memory mapped input/output (IO) device.

Example 29 includes the subject matter of any of Examples 17-28, and wherein receiving a request to access one of the protected resources comprises receiving a request to access dynamic random access memory (DRAM).

Example 30 includes the subject matter of any of Examples 17-29, and wherein receiving the request to access one of the protected resources comprises receiving a request to access non-volatile memory.

Example 31 includes the subject matter of any of Examples 17-30, and wherein receiving a request to access one of the protected resources comprises receiving a request in a non-volatile memory express (NVMe) format.

Example 32 includes the subject matter of any of Examples 17-31, and wherein receiving a request to access one of the protected resources comprises receiving a request in a remote direct memory access (RDMA) format.

Example 33 includes one or more machine-readable storage media comprising a plurality of instructions stored thereon that, when executed, cause a compute node to perform the method of any of Examples 16-32.

Example 34 includes a compute node comprising means for receiving, with a network interface of a compute node, from a requestor node in communication with the compute node, a request to access a protected resource in a memory of the compute node, wherein the request identifies the protected resource by a memory address; means for determining, with the network interface, an identity of the requestor node; and means for determining, with the network interface, as a function of the identity and permissions data associated with the memory address, whether the requestor node has permission to access the protected resource.

Example 35 includes the subject matter of Example 34, and further including means for providing, with the network interface and in response to a determination that the requestor node has permission to access the protected resource, access to the protected resource to the requestor node.

Example 36 includes the subject matter of any of Examples 34 and 35, and wherein the means for providing access to the protected resource comprises means for writing data from the requestor node to the memory address.

Example 37 includes the subject matter of any of Examples 34-36, and wherein the means for providing access to the protected resource comprises means for reading, with the network interface, data from the memory address; and means for sending, with the network interface, the read data to the requestor node.

Example 38 includes the subject matter of any of Examples 34-37, and further including means for denying, with the network interface and in response to a determination that the requestor node does not have permission to access the protected resource, access to the protected resource to the requestor node.

Example 39 includes the subject matter of any of Examples 34-38, and wherein the means for denying access further comprises means for sending a permission violation notification to the requestor node.

Example 40 includes the subject matter of any of Examples 34-39, and wherein the means for denying access further comprises means for sending a NACK message to the requestor node.

Example 41 includes the subject matter of any of Examples 34-40, and wherein the means for denying access further comprises means for sending a permission violation notification to an orchestrator node to manage an operation of the requestor node.

Example 42 includes the subject matter of any of Examples 34-41, and wherein the means for denying access further comprises means for providing an interrupt to a local software stack of the compute node.

Example 43 includes the subject matter of any of Examples 34-42, and further including means for receiving, with the network interface, permissions data from an orchestrator node coupled to the compute node through a network, wherein the permissions data identifies one or more other nodes that are to have permissions that include at least one of write access, read access, or ownership of the one or more protected resources; means for determining, with the network interface and in response to receipt of the permissions data, whether the orchestrator node has authorization to change the permissions to the one or more protected resources; and means for assigning, with the network interface and in response to a determination that the orchestrator node is authorized to change the permissions, the permissions to the protected resources as a function of the permissions data.

Example 44 includes the subject matter of any of Examples 34-43, and further including means for receiving, with the network interface, a request to reassign permissions associated with one or more of the protected resources from a first node to a second node coupled to the compute node through a network; and means for reassigning, with the network interface, in response to receipt of the request, the permissions from the first node to the second node.

Example 45 includes the subject matter of any of Examples 34-44, and wherein the means for receiving a request to access one of the protected resources comprises means for receiving a request to access a memory mapped input/output (IO) device.

Example 46 includes the subject matter of any of Examples 34-45, and wherein the means for receiving a request to access one of the protected resources comprises means for receiving a request to access dynamic random access memory (DRAM).

Example 47 includes the subject matter of any of Examples 34-46, and wherein the means for receiving the request to access one of the protected resources comprises means for receiving a request to access non-volatile memory.

Example 48 includes the subject matter of any of Examples 34-47, and wherein the means for receiving a request to access one of the protected resources comprises means for receiving a request in a non-volatile memory express (NVMe) format.

Example 49 includes the subject matter of any of Examples 34-48, and wherein the means for receiving a request to access one of the protected resources comprises means for receiving a request in a remote direct memory access (RDMA) format.

1. A compute node comprising:
a memory to store one or more protected resources;
a network interface to:
receive, from a requestor node in communication with the compute node, a request to access one of the protected resources, wherein the request identifies the protected resource by a memory address;
determine an identity of the requestor node; and
determine, as a function of the identity and permissions data associated with the memory address, whether the requestor node has permission to access the protected resource.

2. The compute node of claim 1, wherein the network interface is further to provide, in response to a determination that the requestor node has permission to access the protected resource, access to the protected resource to the requestor node.

3. The compute node of claim 2, wherein to provide access to the protected resource comprises to write data from the requestor node to the memory address.

4. The compute node of claim 2, wherein to provide access to the protected resource comprises to:
read data from the memory address; and
send the read data to the requestor node.

5. The compute node of claim 1, wherein the network interface is further to deny, in response to a determination that the requestor node does not have permission to access the protected resource, access to the protected resource to the requestor node.

6. The compute node of claim 5, wherein to deny access further comprises to send a permission violation notification to the requestor node.

7. The compute node of claim 5, wherein to deny access further comprises to send a NACK message to the requestor node.

8. The compute node of claim 5, wherein to deny access further comprises to send a permission violation notification to an orchestrator node to manage an operation of the requestor node.

9. The compute node of claim 5, wherein to deny access further comprises to provide an interrupt to a local software stack of the compute node.

10. The compute node of claim 1, wherein the network interface is further to:
receive permissions data from an orchestrator node coupled to the compute node through a network, wherein the permissions data identifies one or more other nodes that are to have permissions that include at least one of write access, read access, or ownership of the one or more protected resources;
determine, in response to receipt of the permissions data, whether the orchestrator node has authorization to change the permissions to the one or more protected resources; and
assign, in response to a determination that the orchestrator node is authorized to change the permissions, the permissions to the protected resources as a function of the permissions data.

11. The compute node of claim 1, wherein the network interface is further to:
receive a request to reassign permissions associated with one or more of the protected resources from a first node to a second node coupled to the compute node through a network; and
reassign, in response to receipt of the request, the permissions from the first node to the second node.

12. The compute node of claim 1, wherein to receive a request to access one of the protected resources comprises to receive a request to access a memory mapped input/output (IO) device.

13. The compute node of claim 1, wherein to receive a request to access one of the protected resources comprises to receive a request to access dynamic random access memory (DRAM).

14. The compute node of claim 1, wherein to receive the request to access one of the protected resources comprises to receive a request to access non-volatile memory.

15. One or more machine-readable storage media comprising a plurality of instructions stored thereon that, when executed, cause a compute node to:
receive, from a requestor node in communication with the compute node, a request to access one of the protected resources, wherein the request identifies the protected resource by a memory address;
determine an identity of the requestor node; and
determine, as a function of the identity and permissions data associated with the memory address, whether the requestor node has permission to access the protected resource.

16. The one or more machine-readable storage media of claim 15, wherein the plurality of instructions, when executed, further cause the compute node to provide, in response to a determination that the requestor node has permission to access the protected resource, access to the protected resource to the requestor node.

17. The one or more machine-readable storage media of claim 16, wherein to provide access to the protected resource comprises to write data from the requestor node to the memory address.

18. The one or more machine-readable storage media of claim 16, wherein to provide access to the protected resource comprises to:
read data from the memory address; and
send the read data to the requestor node.

19. The one or more machine-readable storage media of claim 15, wherein the plurality of instructions, when executed, further cause the compute node to deny, in response to a determination that the requestor node does not have permission to access the protected resource, access to the protected resource to the requestor node.

20. The one or more machine-readable storage media of claim 19, wherein to deny access further comprises to send a permission violation notification to the requestor node.

21. The one or more machine-readable storage media of claim 19, wherein to deny access further comprises to send a NACK message to the requestor node.

22. A method comprising:
receiving, by a network interface of a compute node, from a requestor node in communication with the compute node, a request to access a protected resource in a memory of the compute node, wherein the request identifies the protected resource by a memory address;
determining, by the network interface, an identity of the requestor node; and
determining, by the network interface, as a function of the identity and permissions data associated with the memory address, whether the requestor node has permission to access the protected resource.

23. The method of claim 22, further comprising providing, by the network interface and in response to a determination that the requestor node has permission to access the protected resource, access to the protected resource to the requestor node.

24. The method of claim 23, wherein providing access to the protected resource comprises writing data from the requestor node to the memory address.

25. The method of claim 23, wherein providing access to the protected resource comprises:
reading, by the network interface, data from the memory address; and
sending, by the network interface, the read data to the requestor node.
